(19) United States
(12) Patent Application Publication
(10) Pub. No.: US 2025/0038317 A1
(43) Pub. Date: Jan. 30, 2025

(54) VENTING OF PRISMATIC BATTERY CELLS

(71) Applicant: GM GLOBAL TECHNOLOGY OPERATIONS LLC, Detroit, MI (US)

(72) Inventors: Diptak BHATTACHARYA, Royal Oak, MI (US); Anil K. Sachdev, Rochester Hills, MI (US); Ryan Patrick Hickey, Austin, TX (US)

(21) Appl. No.: 18/358,431

(22) Filed: Jul. 25, 2023

(51) Int. Cl. H01M 50/169; H01M 50/103; H01M 50/119; H01M 50/15; H01M 50/159; H01M 50/342

(52) U.S. Cl. CPC H01M 50/169; H01M 50/103; H01M 50/119; H01M 50/15; H01M 50/159; H01M 50/3425

(57) ABSTRACT

A battery cell comprises a battery cell stack including A anode electrodes; C cathode electrodes; and S separators, where A, C, and S are integers greater than one. An enclosure configured to house the battery cell stack includes a can body defining a first opening and a second opening at opposite ends of the can body; a lid portion joined to the first opening of the can body by a first brazed filler material that is arranged between the lid portion and the can body and that has a first melting temperature; and a bottom portion joined to the second opening of the can body.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to venting of prismatic battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A battery cell comprises a battery cell stack including A anode electrodes; C cathode electrodes; and S separators, where A, C, and S are integers greater than one. An enclosure configured to house the battery cell stack includes a can body defining a first opening and a second opening at opposite ends of the can body; a lid portion joined to the first opening of the can body by a first brazed filler material that is arranged between the lid portion and the can body and that has a first melting temperature; and a bottom portion joined to the second opening of the can body.

In other features, the bottom portion is attached to the second opening of the can body by a second-brazed filler material that is arranged between the lid portion and the can body and that has a second melting temperature. The first laser-brazed filler material and the second laser-brazed filler material are the same. The first laser-brazed filler material and the second braze filler material are different and the second laser-brazed filler material has a second melting temperature that is different than the first melting temperature. At least one of the lid and the bottom portion includes a pressure-based vent cap.

In other features, the can body, the lid portion and/or the bottom portion are made of the same material. The can body, the lid portion and/or the bottom portion are made of one or more materials selected from a group consisting of steel, stainless steel, and aluminum. The can body is made of a first metal material and at least one of the lid portion and/or the bottom portion is made of a second metal material that is different than the first metal material. The first metal material includes steel and the second metal material includes at least one of aluminum and aluminum alloy. The first braze filler material is selected from a group consisting of tin, an alloy of zinc and aluminum, a eutectic of aluminum and silicon, an alloy of copper, silver and phosphorus, a eutectic of copper and silver, an alloy of copper, magnesium and nickel, and an alloy of nickel, chromium, and iron.

A battery cell comprises a battery cell stack including A anode electrodes; C cathode electrodes; and S separators, where A, C, and S are integers greater than one. An enclosure for a prismatic battery cell is configured to house the battery cell stack and includes a can body defining a first opening and a second opening at opposite ends of the can body; a lid portion joined to the first opening of the can body; and a bottom portion joined to the second opening of the can body. At least one of the lid portion and the bottom portion is crimped to the can body.

In other features, the bottom portion is crimped to the second opening of the can body. The lid portion includes a pressure-based vent cap. The can body, the lid portion and/or the bottom portion are made of the same material. The can body, the lid portion and/or the bottom portion are made of a material selected from a group consisting of steel, stainless steel, and aluminum. The can body is made of a first metal material and at least one of the lid portion and/or the bottom portion is made a second metal material that is different than the first metal material.

In other features, the first metal material includes steel and the second metal material includes aluminum. The lid portion and the bottom portion are crimped to the can body. The lid portion is crimped to the can body and the bottom portion is brazed to the can body. The lid portion is brazed to the can body and the bottom portion is crimped to the can body.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes, anode electrodes, and separators arranged in a battery cell enclosure according to the present disclosure;

FIG. 2A is a perspective view of an example of a prismatic battery cell according to the present disclosure;

FIG. 2B is a perspective view of an example of a prismatic battery cell with a pressure-based vent cap according to the present disclosure;

FIG. 3 is a graph illustrating an example of temperature and pressure of a prismatic battery cell during a thermal runaway event;

FIG. 4 is a perspective view of an example of a prismatic battery cell with a pressure-based vent cap during a thermal runaway event;

FIGS. 5A and 5B are perspective views of an example of a prismatic battery cell including a brazed or crimped lid portion and/or a bottom portion that provide temperature or pressure-based venting according to the present disclosure;

FIGS. 6A and 6B are perspective views of an example of a prismatic battery cell including a laser-brazed or crimped lid portion (with a pressure-based vent cap) and/or a bottom portion that provide temperature and/or pressure-based venting according to the present disclosure; and

FIG. 7 illustrates an example of temperature as a function of time during a thermal runaway event and melting temperatures of various laser-brazed filler materials according to the present disclosure.

In the drawings, reference numbers may be reused to identify similar and/or identical elements.

### DETAILED DESCRIPTION

While prismatic battery cells according to the present disclosure are shown in the context of electric vehicles, the prismatic battery cells can be used in stationary applications and/or other applications.

During a thermal runaway event, a series of exothermic reactions occur within a battery cell leading to significant gas release, rapid pressure buildup in the battery cell, and increased battery cell temperature. During the thermal runaway event, the vent gases should be released from the battery cell through one or more specified exit paths. In existing prismatic battery cells, a pressure-based vent opens a small area on the lid portion when pressure within the battery cell is greater than a predetermined pressure. All of the gases and burning materials need to exit through this one vent area.

Significant energy is retained in the battery cell for a longer period of time, which allows the exothermic reaction to continue to build. In other words, during thermal runaway events, a pressure-activated vent on the lid (as shown in FIG. 2B) may not be sufficient to release all the hot gases and electrode particles. A local buildup of pressure and/or hot spots can lead to breach of the battery cell walls along a wide face. The breach releases the gases from unwanted locations that could lead to heating of neighboring battery cells and triggering thermal runway propagation in the battery pack. Therefore, the venting strategy described herein is modified to provide larger vent areas release of the gases so that the can faces do not get punctured.

The present disclosure relates to prismatic battery cells including a lid portion and/or a bottom portion that are joined to a can body using one or more braze filler materials. In some examples, laser brazing is used. During thermal runaway, as the cell temperature rise, the braze material will melt at predetermined temperatures and separate the lid/bottom from the can body and provide an exit pathway for the gases. Alternatively, the lid and the bottom can be joined to the cans using mechanical double seaming (crimping). The crimped will fail at predetermined pressure level to allow lid/bottom separation from the can body to release hot gases through the can ends. In some examples, laser brazing is used instead of conventional laser welding. The one or more braze filler materials have melting temperatures that correspond to one or more desired temperatures to vent hot gases from the can body during a thermal runaway event. In some examples, the lid portion and/or the bottom portion are attached to the can body using the same braze filler material such that both the lid portion and/or the bottom portion separate from the can body and vent the gases at the same temperature.

In other examples, the lid portion and/or the bottom portion are attached to the can body using different braze filler materials such that the lid portion and/or the bottom portion vent hot gases at different temperatures. The melting temperatures of the braze filler materials are lower than the melting temperature(s) of the material(s) used to make the can body.

In some examples, the lid portion and/or the bottom portion span the entire top and bottom openings of a can body the enclosure. In some examples, the lid portion may also include a pressure-based vent (e.g., a vent cap or vent valve) that releases vent gases at a predetermined pressure (through an opening having a relatively a relatively small area).

In some examples, the lid portion and bottom portion can be made of the same material or different materials than the materials that are used for the can body to provide additional controlled failure stages. For example, the lid portion and/or the bottom portion may be made of aluminum or aluminum alloy and the can body can be made of steel alloys. The lid portion and/or the bottom portion are attached to the can body using one or more braze filler materials. The lid portion may optionally include a pressure-based vent. During a thermal runaway event, the pressure-based vent opens in response to the pressure increase inside the battery cell. Then, if the temperature of the battery cell continues to increase, the braze filler material melts to separate the lid portion and/or the bottom portion from the can body (creating additional larger vent areas). Then, the lid portion will melt. The last part to melt will be the body portion.

In other examples, the lid portion and/or the bottom portion are attached to the can body using crimping (rather than the braze filler materials and laser brazing). The lid portion and/or bottom portion can be made of the same material or different materials than the can body. For example, the can body can be made of steel. The lid portion and/or the bottom portion can be made of aluminum and are crimped to the can body. The lid portion may optionally include a pressure-based vent. During a thermal runaway event, the pressure-based vent opens in response to the pressure increase in the battery cell. If pressure in the battery cell continues to increase, the crimp at the lid portion and/or the bottom portion fails to cause the lid portion and/or the bottom portion to separate from the can body. Then, if the temperature continues to rise, the lid portion and the body portion melt.

The prismatic battery cell according to the present disclosure can be designed to release vent gases at specified temperatures and through specified pathways (e.g., through the top opening and the bottom opening at the same temperature, through the top opening and then the bottom opening, or through the bottom opening and then the top opening). When the lid portion and/or the bottom portion burst due to temperature increases (brazed) or pressure increases (crimped), the lid portion and/or the bottom portion separate from the can body and open up a much larger vent area as compared to pressure-based vent caps on the lid portion.

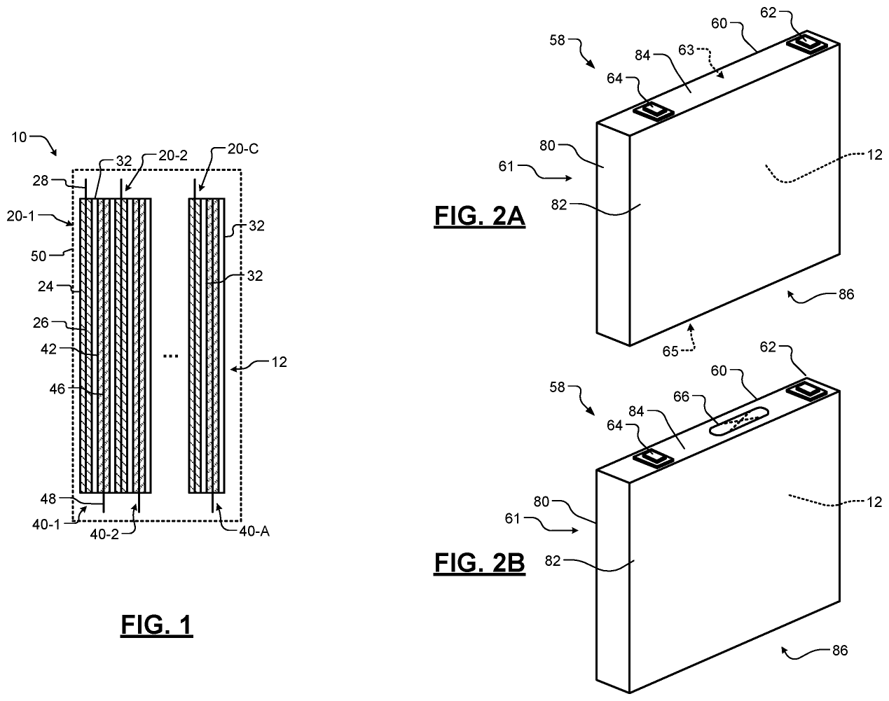

Referring now to FIG. 1, a battery cell 10 includes C cathode electrodes 20, A anode electrodes 40, and S separators 32 arranged in a predetermined sequence in a stack 12 located in an enclosure 50. The C cathode electrodes 20-1, 20-2, . . . , and 20-C (where C is an integer greater than one) include cathode active layers 24 arranged on one or both sides of cathode current collectors 26. The A anode electrodes 40-1, 40-2, . . . , and 40-A (where A is an integer greater than one) include anode active layers 42 arranged on one or both sides of the anode current collectors 46.

In some examples, the anode active layers 42 and/or the cathode active layers 24 are free-standing electrodes that are arranged adjacent to (or attached to) the current collectors. In some examples, the anode active layers 42 and/or the cathode active layers 24 comprise coatings including one or more active materials, one or more conductive fillers/additives, and/or one or more binder materials. In some examples, the battery cells and/or electrodes are manufactured by applying a slurry to coat the current collectors in a roll-to-roll manufacturing process. In some examples, the cathode current collectors 26 and/or the anode current collectors 46 comprise a foil layer. In some examples, the current collectors are made of one or more materials selected from a group consisting of copper, stainless steel, brass, bronze, zinc, aluminum, and alloys thereof.

Referring now to FIGS. 2A and 2B, a prismatic battery cell 58 includes an enclosure 60. In some examples, the enclosure 60 has rectangular cross-sections in x-, y- and z-axis planes. The enclosure 60 includes a can body 61 including sides 80 and 82 defining a top opening 63 and a bottom opening 65. As will be described further below, a lid portion 84 and a bottom portion 86 are laser brazed or crimped onto the can body 61 to enclose the top opening 63 and the bottom opening 65, respectively. The prismatic battery cell 58 includes external terminals 62 and 64 passing through the lid portion 84. The stack 12 of the C cathode electrodes 20, the A anode electrodes 40, and the S separators 32 is arranged in the enclosure 60.

The external terminals 62 and 64 are connected to external tabs of the A anode electrodes 40 and the C cathode electrodes 20, respectively. In FIG. 2A, the lid portion 84 does not include a pressure-based vent. In FIG. 2B, the lid portion 84 includes a pressure-based vent cap 66 opening a vent area significantly smaller than the vent area of the top opening 63 and/or the bottom opening 65. The pressure-based vent cap 66 is configured to release vent gases when pressure within the enclosure 60 is greater than a predetermined pressure.

When the prismatic battery cell uses laser brazing to attach the lid portion 84 and the bottom portion 86 to the can body 61, the lid portion 84 and the bottom portion 86 open in response to the temperature increasing above a melting temperature of the braze filler material that is used to provide a primary or secondary vent having a large surface area. When the prismatic battery cell using crimping to attach the lid portion 84 and the bottom portion 86 to the can body 61, the lid portion 84 and the bottom portion 86 open in response to the pressure in the battery cell increasing above a predetermined pressure (greater than the release pressure of the vent cap 66).

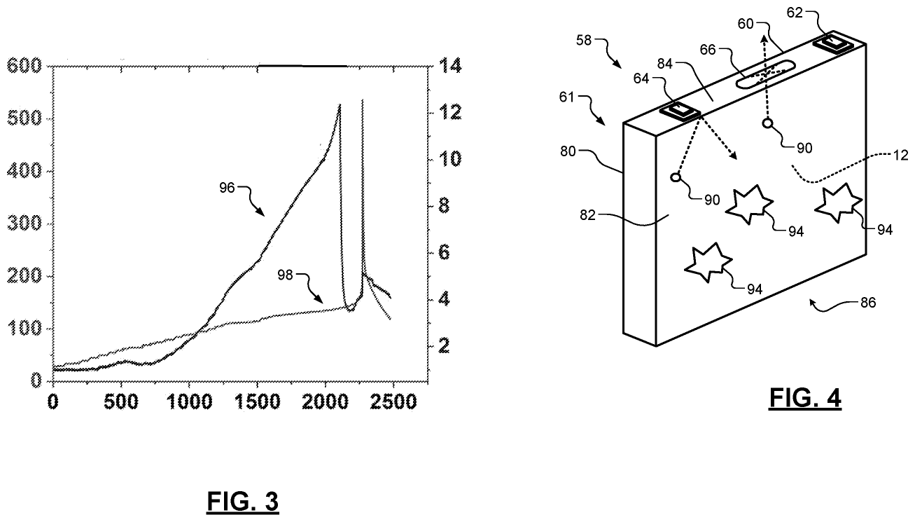

Referring now to FIGS. 3 and 4, an example of temperature and pressure of a battery cell (without venting described herein) during a thermal runaway event is shown. During the thermal runaway event, the exothermic reactions produce gases inside the battery cell, which increases pressure in the battery cell. As the pressure 96 of the vent gases increases, the temperature 98 also increases at a first rate. When the pressure-based vent bursts, the temperature spikes and may reach temperatures greater than 1000° C. The increased temperature of the vent gases and burning electrodes, electrolyte, and/or separator materials may cause the surface of the battery cell to reach temperatures from 700° C. to 800° C.

The pressure-based vent releases some of the vent gas pressure. However, the vent area is small and ejection of the vent gases and/or burning materials is limited. The temperature of the vent gases increases rapidly after the vent cap bursts. In FIG. 4, ionic particles 90 may be created by the hot gases and/or burning electrodes, electrolyte, and/or separator materials. The ionic particles 90 can cause arcing with adjacent conducting structures.

When the can body 61 is made of aluminum, the sides 80 and 82 of the can body 61 can melt at local hot spots 94. Openings in the can body 61 release combustion gases and/or burning electrode, electrolyte, and/or separator materials sideways in the direction of adjacent battery cells. Increased heating of the adjacent battery cells can cause heating and/or thermal runaway in the adjacent battery cells to occur (e.g., thermal runaway propagation (TRP)). When the can body 61 is made of steel, the can body 61 can soften and/or burst due to the heat and pressure of the vent gases and/or burning electrode, electrolyte, and/or separator materials.

As can be seen in FIG. 4, the opening provided by the pressure-based vent cap 66 has a relatively small area which can become clogged due to the burning electrode, electrolyte, and/or separator materials that are ejected. As a result of the restricted vent area, the energy of the battery cell is released more slowly, the exothermic reaction continues, and higher pressures and/or temperatures may be reached.

As will be described further below, the prismatic battery cell according to the present disclosure provides one or more vent openings during thermal runaway. Each of the vent openings provides a larger vent area to allow higher mass loss from the battery cell in a shorter period of time during a thermal runaway event. When the lid and bottom separate from the can body in a controlled manner by melting of the brazed can/cap joint, one or more large openings are created. When the vent bursts and the one or more large openings are created, the energy of the battery cell is released quickly and the energy remaining in the battery cell falls more quickly to a lower energy level that can be extracted by battery cooling systems.

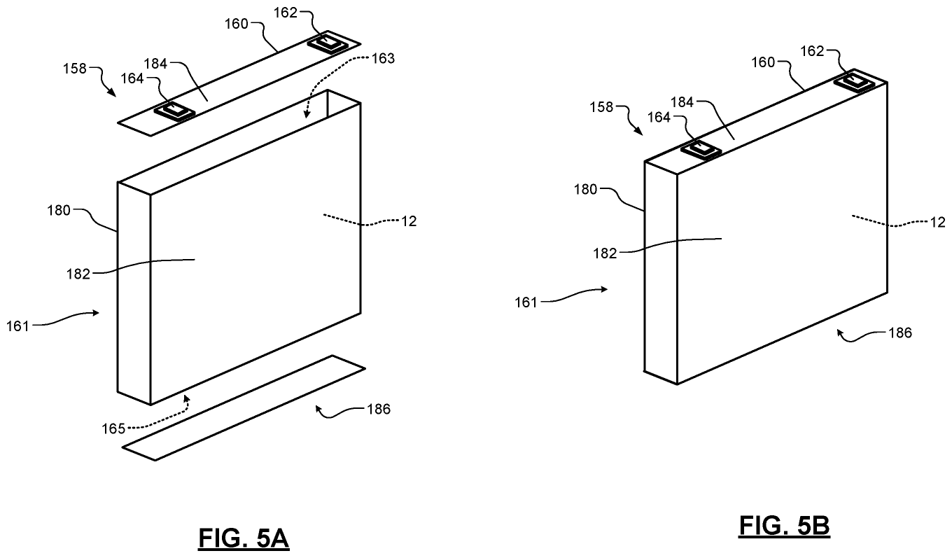

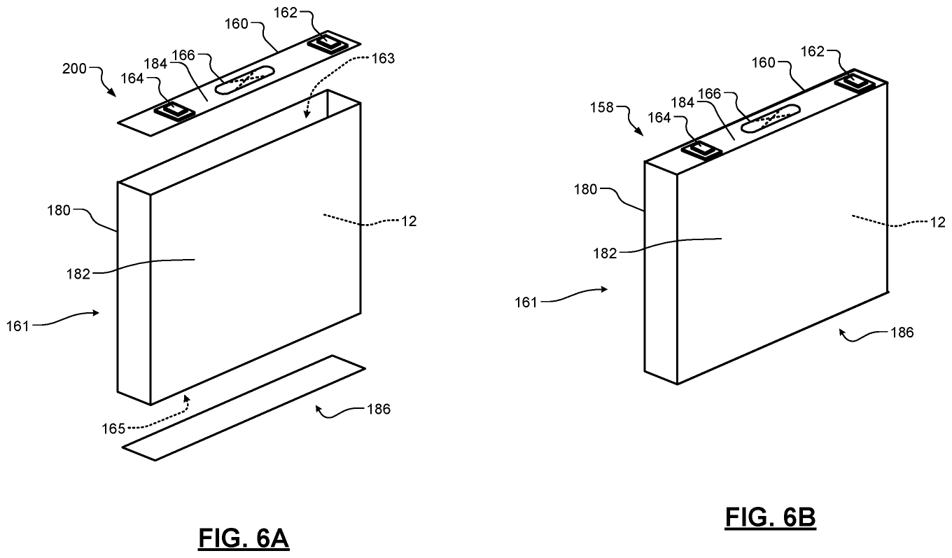

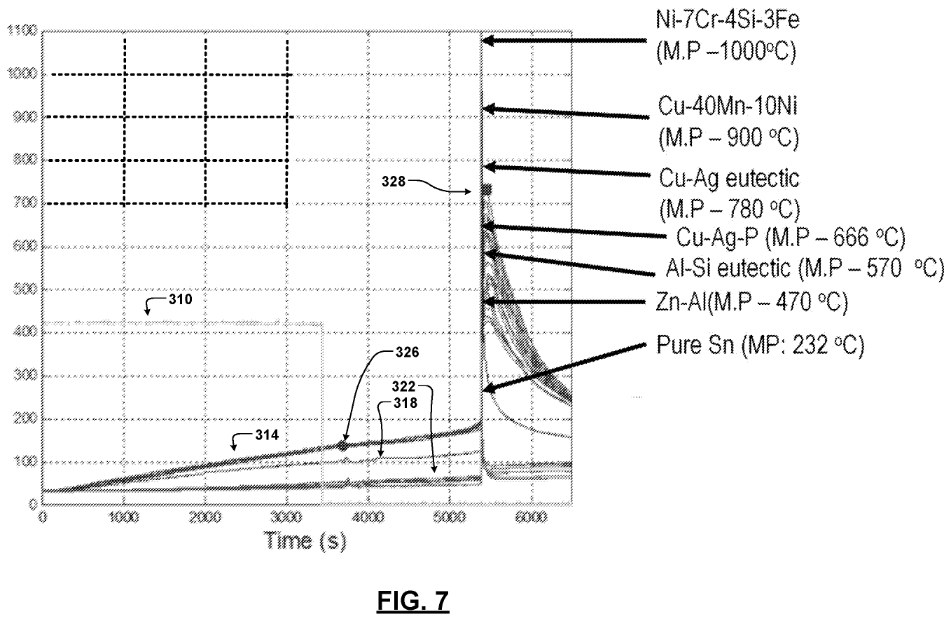

Referring now to FIGS. 5A to 6B, examples of prismatic battery cells 158 and 200 with a lid portion and/or a bottom portion that vent in response to temperature and/or pressure of the battery cell are shown, respectively. In FIGS. 5A and 5B, the prismatic battery cell 158 includes an enclosure 160. In some examples, the enclosure 160 has rectangular cross-sections in x-, y- and z-axis planes, although cylindrical, elliptical, polygonal, and/or other cross sectional shapes can be used. The enclosure 160 includes a can body 161 including sides 180 and 182 (e.g., an open-ended rectangular cube). A lid portion 184 and a bottom portion 186 are attached to the can body 161 using laser brazed filler material(s) and/or crimping to enclose first and second openings 163 and/or 165 of the can body 161. The prismatic battery cell 158 includes external terminals 162 and 164.

The stack 12 including the C cathode electrodes 20, the A anode electrodes 40, and the S separators 32 is arranged in the enclosure 160. The external terminals 162 and 164 are connected to external tabs of the electrodes. In FIGS. 5A and 5B, the lid portion 184 does not include a vent cap.

In FIGS. 6A and 6B, the lid portion 184 of the prismatic battery cell 200 includes a vent cap 166. The vent cap 166 is configured to release when pressure within the enclosure 160 is greater than a predetermined pressure. In some examples, the vent cap 166 occupies less than 25% of the surface area of the lid portion 184.

In some examples, the lid portion and/or the bottom portion are joined to the can body using one or more laser-brazed filler materials having one or more melting temperatures that correspond to desired temperatures to vent the lid portion and/or the bottom portion of the can body during a thermal runaway event. The melting temperatures of the laser-brazed filler materials are lower than melting temperatures of the materials used to make the can body and the lid/bottom.

In some examples, the lid portion and/or the bottom portion are attached to the can body using the same braze filler material such that both the lid portion and/or the bottom portion are separated from the can body at the same temperature to vent the hot gases out of the cell. In some examples, the lid portion and/or the bottom portion are attached to the can body using different braze filler materials such that the lid portion and/or the bottom portion separate at different temperatures. In some examples, the lid portion may also include a pressure-based vent that releases at a predetermined pressure. Using different braze filler materials allows control of the direction of ejection of hot gases and/or ionic particles during thermal runaway.

In some examples, the lid portion and bottom portion can be made of the same material or different materials than the material used for the can body to provide additional venting control measures. For example, the lid portion and/or the bottom portion may be made of aluminum or aluminum alloy and the can body can be made of steel. The lid portion and/or the bottom portion are attached to the can body using one or more braze filler materials. The lid portion may include a pressure-based vent. During a thermal runaway event, the pressure-based vent opens in response to the pressure increase. Then, if the temperature continues to rise, the laser-brazed filler material melts to separate the lid portion and/or the bottom portion from the can body. Then, if temperatures continue to rise, the lid and the bottom will melt. The last part of the can to melt will be the body portion.

In some examples, the lid portion and/or the bottom portion can be attached to the can body using crimping. The crimping allows the lid portion and/or the bottom portion to be released from the can body at a predetermined pressure in the battery cell. The lid portion and/or the bottom portion can be made of the same material or different materials than the can body to provide additional venting measures.

For example, the can body can be made of steel and the lid portion and/or the bottom portion can be made of aluminum that is crimped to the steel can body. The lid portion may include a pressure-based vent. During a thermal runaway event, the pressure-based vent opens in response to the increased pressure of the vent gases in the battery cell. If the pressure in the battery cell continues to increase, one or both of the crimps fail and the lid portion and/or the bottom portion separate from the can body. If the temperature continues to increase, the lid portion and/or the body portion melt (e.g., before the can body melts).

Referring now to FIG. 7, a graph illustrates an example of temperature as a function of time during a thermal runaway event. At 310, battery cell voltage is shown. At 314, cell surface temperature is shown. At 318, vent gas pressure is shown. At 322, reactor gas temperature is shown. At 326, a first venting event occurs. At 328, a maximum cell housing temperature is reached.

Different types of brazing materials can be selected to provide venting at one or more predetermined temperatures. For example, pure tin (Sn) has a melting temperature of 232° C. For example, an alloy of zinc (Zn) and aluminum (Al) has a melting temperature of 470° C. For example, a eutectic of Al and silicon (Si) has a melting temperature of 570° C. For example, an alloy of copper (Cu), silver (Ag) and phosphorous (P) has a melting temperature of 666° C. For example, a eutectic of Cu and Ag has a melting temperature of 780° C. Additional braze fillers with higher melting temperatures can be used such as alloys of copper, magnesium, and nickel (e.g., Cu-40Mn-10Ni) or nickel, chromium, and iron (e.g., Ni-7Cr-4-3Fe), which have higher melting temperatures of 900° C. and 1000° C., respectively.

As can be appreciated, other variations of the features described above can be used. For example, laser brazing the top or bottom portion of the can body can be combined with crimping of the bottom or top portion of the can body, respectively.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
a battery cell stack including:
A anode electrodes;
C cathode electrodes; and
S separators, where A, C, and S are integers greater than one; and
an enclosure configured to house the battery cell stack including:
a can body defining a first opening and a second opening at opposite ends of the can body;
a lid portion joined to the first opening of the can body by a first brazed filler material that is arranged between the lid portion and the can body and that has a first melting temperature; and
a bottom portion joined to the second opening of the can body.

2. The battery cell of claim 1, wherein the bottom portion is attached to the second opening of the can body by a second brazed filler material that is arranged between the lid portion and the can body and that has a second melting temperature.

3. The battery cell of claim 2, wherein the first brazed filler material and the second brazed filler material are the same.

4. The battery cell of claim 2, wherein the first brazed filler material and the second braze filler material are different and the second brazed filler material has a second melting temperature that is different than the first melting temperature.

5. The battery cell of claim 1, wherein at least one of the lid portion and the bottom portion includes a pressure-based vent cap.

6. The battery cell of claim 1, wherein the can body, the lid portion and/or the bottom portion are made of the same material.

7. The battery cell of claim 6, wherein the can body, the lid portion and/or the bottom portion are made of one or more materials selected from a group consisting of steel, stainless steel, and aluminum.

8. The battery cell of claim 1, wherein the can body is made of a first metal material and at least one of the lid portion and/or the bottom portion is made of a second metal material that is different than the first metal material.

9. The battery cell of claim 8, wherein the first metal material includes steel and the second metal material includes at least one of aluminum and aluminum alloy.

10. The battery cell of claim 1, wherein the first braze filler material is selected from a group consisting of tin, an alloy of zinc and aluminum, a eutectic of aluminum and silicon, an alloy of copper, silver and phosphorus, a eutectic of copper and silver, an alloy of copper, magnesium and nickel, and an alloy of nickel, chromium, and iron.

11. A battery cell comprising:
a battery cell stack including:
A anode electrodes;
C cathode electrodes; and
S separators, where A, C, and S are integers greater than one; and
an enclosure for a prismatic battery cell configured to house the battery cell stack and including:
a can body defining a first opening and a second opening at opposite ends of the can body;
a lid portion joined to the first opening of the can body; and
a bottom portion joined to the second opening of the can body,
wherein at least one of the lid portion and the bottom portion is crimped to the can body.

12. The battery cell of claim 11, wherein the lid portion is crimped to the first opening of the can body and the bottom portion is crimped to the second opening of the can body.

13. The battery cell of claim 11, wherein the lid portion includes a pressure-based vent cap.

14. The battery cell of claim 11, wherein the can body, the lid portion and/or the bottom portion are made of the same material.

15. The battery cell of claim 14, wherein the can body, the lid portion and/or the bottom portion are made of a material selected from a group consisting of steel, stainless steel, and aluminum.

16. The battery cell of claim 11, wherein the can body is made of a first metal material and at least one of the lid portion and/or the bottom portion is made a second metal material that is different than the first metal material.

17. The battery cell of claim 16, wherein the first metal material includes steel and the second metal material includes aluminum.

18. The battery cell of claim 13, wherein the lid portion is crimped to the first opening of the can body and the bottom portion is brazed to the second opening of the can body.

19. The battery cell of claim 13, wherein the lid portion is brazed to the first opening of the can body and the bottom portion is crimped to the second opening of the can body.
